(19) United States
(12) Patent Application Publication
(10) Pub. No.: US 2008/0288361 A1
(43) Pub. Date: Nov. 20, 2008

(54) System and method for lead generation and lead demand fulfillment

(76) Inventors: Geoffrey Rego, Cupertino, CA (US); Verna Rego, Cupertino, CA (US)

Correspondence Address: SCHWEGMAN, LUNDBERG & WOESSNER, P.A., P.O. BOX 2938, MINNEAPOLIS, MN, 55402, US

(21) Appl. No.: 11/804,266

(22) Filed: May 17, 2007

(51) Int. Cl. G06F 19/00

(52) U.S. Cl. 705/26

(57) ABSTRACT

A method and a system of lead generation and lead demand fulfillment are provided. In example embodiments, a first environment may be maintained for a first party to present information related to an on sale transaction lead that the first party is interested in selling; a second environment may be maintained for a second party to present information related to a demanded transaction lead, that the second party is interested in buying; and a third environment may be provided to facilitate a transaction between the first party and the second party, including a sale and purchase of a transaction lead. In an example embodiment, a lead referral system for facilitating a lead referral network expansion in an online transaction lead auction system may be presented. In an example embodiment, the system may include a first and a second user interface to receive information and a server to process the received information.

### TECHNICAL FIELD

The inventive subject matter relates generally to electronic commerce and more specifically to systems and methods for lead generation and lead demand fulfillment.

### BACKGROUND

Currently several different marketing activities are focused on identifying prospective customers for products or services, also known as lead generation. Lead generation is a marketing term that refers to the creation of well-matched connections between consumers and target corporate vendors. A common method used by vendors is the posting of advertisements in public media, such as television, newspapers and magazines and on Web pages on the Internet. Vendor companies may also ask current customers for lead referrals and may leverage affiliate marketing.

Affiliate marketing is a method of promoting web businesses in which an affiliate may be rewarded for every visitor, subscriber, customer, and/or sale provided through his/her efforts. Compensation or commission may be made based on a certain value for each exposure (CPM), visit (e.g., PAY PER CLICK), registrant or new customer (e.g., PAY PER LEAD), sale (usually a percentage, Pay per sale or revenue share), or any combination of them.

There are two types of affiliate models. One where the affiliate host web forms, collect data and then send the information to the marketer. The other one is where the affiliate just redirects traffic to the marketer and the marketer collects prospect information and just pays the affiliate for redirecting traffic companies in a business model whereby customers from each company are directed to the affiliate company's Web site, store or agent. Subsequently, the customer information is collected and forwarded to the marketer.

Another lead generation process is known as the incentive model, in which companies use special offers to attract leads, providing incentive deals and free gifts to potential buyers who may be interested in specific product areas. An incentive is offered in exchange for contact and other personal information. This information is then aggregated and offered for sale to interested vendors.

There exists another model where a prospect, in pursuit of a free offer, has to fill several forms each destined for a particular marketer. The key here is each marketer pays the aggregator an amount, the aggregator sums up all these amounts and when the amounts total more than the free offer then the prospect gets the free offer. An example of companies, which offer this model, is www.netblue.com.

As more and more Internet users are realizing the ease and convenience of online shopping and product information research, the Internet is increasingly being used as a medium for collecting lead information. Internet portals offer target vendors the opportunity to post white papers and other collaterals on the portal Web site, which is mass-marketed to large audiences. When potential customers visit the portal searching for information on a chosen subject, the target vendor white papers or other collaterals are offered in exchange for information about the potential customer. This lead is then delivered to the target vendor. An example of these central portals are www.techtarget.com, www.netline.com, and www.knowledgestorm.com.

A more traditional model also popular through the Internet is for vendor companies to purchase a list of potential leads matching their required attributes. Lists are generated by lead sellers filtering metadata from databases of lead information collected through multiple methods. The conversion rate on these lists is less than 2 percent, since list information, management is conducted automatically, and the accuracy, authenticity and timeliness of information are usually not verified, leading to high error rates. However, vendor companies have the option of purchasing verified lists at a higher price. These lists are manually verified by telephone as accurate and relevant.

Lead generation companies typically receive payment per lead generated from the target vendor, though other payment methods for lead generation include commission on the sales made or a combination thereof.

The limitations of these methods of lead generation and lead information exchange are many. The primary limitation is a low conversion rate where there is a set of well-matched candidates for product purchase within a larger set of poorly matched candidates. This can lead to conversion rates of not more than 5 percent.

Another example business model for lead generation is an online lead market place system where buyer and sellers of lead can bid on leads via an auction. In one specific model used for example by LEADPILE.COM, a consumer may enter a web site associated with a company and submit, on a Web form, an interest in a specific product or service. In this model the Web form is actually powered by LEADPILE.COM and the collected information is then sold by the company to LEADPILE.COM and auctioned at the market place system.

One clear disadvantage of this model may be that the company selling the information to LEADPILE.COM may carry the risk of violating the privacy policy of the consumer.

The Controlling the Assault of Non-Solicited Pornography And Marketing Act (CAN-SPAM) of 2003 also poses risks to target vendors who are unfamiliar with the constantly changing legal requirements of soliciting leads and using lists over the Internet.

### BRIEF DESCRIPTION OF THE DRAWINGS

Some embodiments are illustrated by way of example and not limitation in the figures of the accompanying drawings in which: A better picture than FIG. 1 I sent you earlier.

FIG. 1 is a view of an example lead transaction registration;

FIG. 2 is a high-level diagram depicting an example user-server system within which an example lead transaction may take place;

FIG. 3 is a block diagram illustrating a lead market place in network connection with users;

FIG. 4 is a block diagram illustrating lead generation system applications;

FIG. 5 is a high-level transaction lead generation entity-relationship diagram, illustrating various tables that may be maintained within the databases;

FIG. 6 is a high-level flow diagram illustrating an example embodiment of a method for transaction lead generation;

FIG. 7 is a high-level flow diagram illustrating an example embodiment of a method for registering transaction leads;

FIG. 8 is a flow diagram illustrating an example embodiment of a method for registering demands for transaction leads;

FIG. 9 is a flow diagram illustrating an example embodiment of a method for managing a transaction lead referral system;

FIG. 10 is a sequential flow diagram illustrating an example embodiment of exclusive bidding process in a lead auction system;

FIG. 11 is a screen shot illustrating an example embodiment of a user interface facilitating lead category selection;

FIG. 12 is a screen shot depicting an example embodiment of a user interface for capturing lead basic information;

FIG. 13A is a screen shot illustrating an example embodiment of a user interface for receiving information related to an actual buyer;

FIG. 13B is a screen shot illustrating an example embodiment of a user interface for receiving lead category attributes;

FIG. 14 is a screen shot depicting an example embodiment of a user interface for capturing detailed buyer/seller account information;

FIG. 15 is a screen shot illustrating an example embodiment of a user interface for capturing demanded lead information from a lead buyer;

FIG. 16A is a screen shot illustrating an example embodiment of a user interface for creating subscription criteria;

FIG. 16B is a screen shot illustrating an example embodiment of a user interface for receiving lead filter information from a lead buyer;

FIG. 17 is a screen shot depicting an example embodiment of a user interface for creating a new subscriptions;

FIG. 18 is a screen shot illustrating an example embodiment of a user interface for receiving feedback from lead buyers and lead sellers;

FIG. 19 is a screen shot illustrating an example embodiment of a user interface for inviting others to join the lead referral system;

FIG. 20 s a screen shot illustrating an example embodiment of a user interface for showing the lead referral network of an account; and

FIG. 21 is a block diagram illustrating a diagrammatic representation of a machine in the example form of a computer system.

### DETAILED DESCRIPTION

Example methods and systems of lead generation and lead demand fulfillment are described. In the following description, for purposes of explanation, numerous specific details are set forth in order to provide a thorough understanding of example embodiments. It will be evident, however, to one skilled in the art that the present invention may be practiced without these specific details.

For the purpose of present application, the term “actual buyer” shall be taken to include, but not be limited to, a prospective buyer of an item or a service which may also be a “transaction lead” (e.g., Mike is interested in buying a car, John knows that and may be willing to offer this information as lead in a lead market place to prospective lead buyers).

For the purpose of present application, the term “Actual seller” shall be taken to include, but not be limited to, a prospective seller of an item or a service which may be interested in an actual buyer, e.g., a “transaction lead.”

A method for lead generation is provided. The method may include maintaining a first environment (e.g., a Web page, such as a user interface of a lead market place) for a first party (hereinafter referred to as a lead seller) to present information related to one or more on sale transaction lead that the lead seller is interested in selling.

The method may also include maintaining a second environment (e.g., a Web page, such as a user interface of a lead market place) for a second party (hereinafter referred to as a lead buyer) to present information related to one or more demanded transaction lead that the lead buyer is interested in buying;

The method may further include providing a third environment (e.g., a Web page such as online lead market place) to facilitate a transaction between the lead seller and the lead buyer, the transaction may include sale and purchase of one or more transaction leads.

According to example embodiments, the lead buyer may subscribe to a transaction lead category provided by the second environment. The lead seller may specify one or more transaction lead categories for the on sale transaction. The lead seller may be either subject of a transaction lead or a third party providing information pertaining to a transaction lead.

In example embodiments, the first environment, the second environment, and the third environments may include web pages hosted by a server facilitating a user to perform one or more actions such as browsing information and inputting data. The information related to the at least one on sale transaction lead may include selling preferences defined by the lead seller (e.g., a lead buyer score eligibility, a timeframe, an exclusive transaction lead minimum price, a non-exclusive transaction lead minimum price, and a seller black list containing a list of names of people the seller does not want to sell leads to them). The information related to the at least one demanded transaction lead may include buying preferences defined by the lead buyer (e.g., a lead seller score eligibility, a timeframe, an exclusive transaction lead maximum price, a non-exclusive transaction lead maximum price, and a buyer black list containing a list of names of people the buyer does not want to buy leads from them).

According to example embodiments, the facilitating a transaction may include matching a demanded transaction lead with an on sale transaction lead, at least in accordance with the selling preferences and the buying preferences. The lead market place may notify the lead seller and the lead buyer of a matching transaction lead.

In example implementations, the third environment may be a market place environment (e.g. an online auction) for the lead buyer to participate in a bidding process for the matched on sale transaction lead. The lead buyer may have the option of authorizing the online auction system, to manage transaction lead purchasing processes, automatically, in accordance with predefined parameters. For example, the predefined parameters may include a maximum bidding price, a zip code, a lead seller rating, and at least one of a maximum amount spent for leads in a period, or a maximum number of leads purchased in a predetermined period.

According to example embodiments, the auction system may determine a maximum number of successful lead buyers for a transaction lead, of one or more on sale transaction leads. The lead seller may specify an auction period and upon ending of the auction period, the auction system may automatically identify one or more successful bidders. In rating system, managed by the lead market place, the lead seller may receive ratings from the one or more successful bidders, and the one or more successful bidders may receive a rating from the lead seller. The ratings may include good lead, bad lead, or duplicate lead.

According to an example embodiment, the lead seller may have identification attributes. The identification attributes may be prevented from being disclosed to the lead buyer and may only be traded in an exchange environment.

In one example embodiment, the second environment may facilitate transaction lead buying campaigns including presenting the lead buyer with all subscription options. The subscription options may include presenting the lead buyer with options to define a maximum bid price for a subscription selection, a maximum number of transaction lead to be purchased during a predefined timeframe, and a maximum amount to be spent in the predefined timeframe.

According to example embodiments, the auction system may inform each of one or more successful bidders, via email messages, that he/she is an auction winner, and may automatically transfer the purchase amount, and deduct the commission. The lead market place may provide a public community forum for public discussions on lead transactions. In the public community forums, only comments left by lead buyers and lead sellers may be disclosed.

A method for presenting a lead referral system for facilitating a lead referral network expansion and diversifying transactions transacted in an online transaction lead auction system is provided.

According to example embodiments, the method may include receiving information related one or more referred party (e.g., a lead or someone who has information about a lead) from a lead referring party referring the one or more referred parties to the lead referral system (e.g., a sub-system of the lead market place). The method may include verifying the information related to the one or more referred party and managing lead referral relationships between the lead referring party and the one or more referred parties. The method may further include compensating the lead referring party based on a percentage of a transaction amount, related to a transaction completed as a result of a lead referral by the lead referring party, or lead referrals by one or more parties referred to the lead referral system by the lead referring party.

In example embodiments, the referral system may transfer to a lead referring party account, funds from an account holding commissions payable to the online auction system, deducted from the transaction amount. The lead referral system may be accessible to all users including one or more lead buyers and a lead seller associated with a transaction. Managing a lead referral relationship may not limit a number of lead referral relationships. Compensating the lead referring party may include a number, indicating a maximum number of levels of direct indirection between lead referrals.

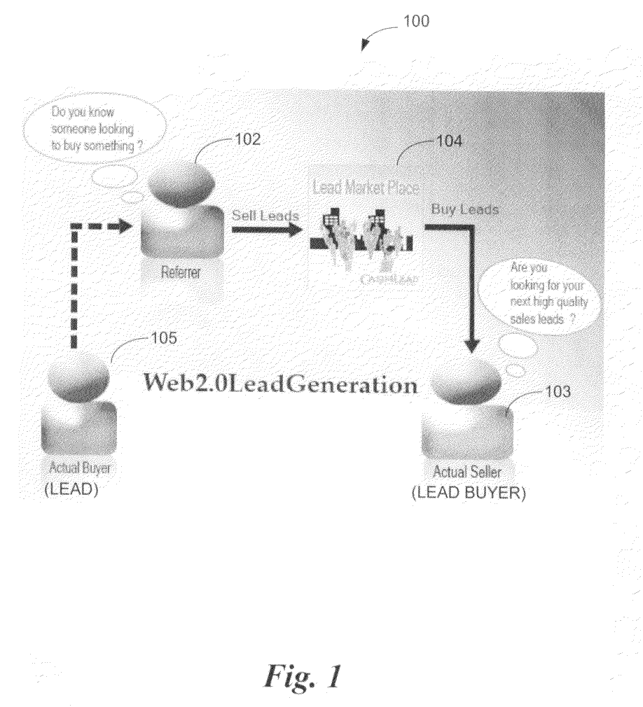

FIG. 1 is a view 100 of an example lead transaction registration. In one example embodiment, the lead seller 102 may have one or more leads to offer for sale. The lead seller 102 may offer the leads for sale in the lead market place 104. The lead buyer 103 may be looking for a lead, in the market place 104, for the items or services that the lead buyer 103 may have for sale. The lead buyer 103 may find the leads offered by the lead seller 102 in the lead market place 104 and enter into a transaction with that seller.

In an example embodiment, the lead offered by the lead seller 102 may be the lead 105 who might be the actual buyer of an item or a service. According to one example embodiment, the lead market place 104 may maintain a Web page for the lead seller 102 to present information related to one or more on sale transaction leads that the lead seller is interested in selling.

In another example embodiment, the lead market place 104 may maintain a another Web page for a lead buyer 103 to present information related to one or more demanded transaction leads, namely, a transaction lead that the lead buyer 103 is interested in buying. In another example embodiment, the lead market place 104 may provide a Web page to facilitate a transaction for the lead seller 102 and the lead buyer 103, the transaction including a sale and purchase of a transaction lead.

In example embodiments, the lead market place 104 may provide for the lead buyer 103 to subscribe to a transaction lead category provided by the lead buyer 103. The lead market place 104 may also provide for the lead seller 102 to specify one transaction lead category for the on sale transaction. The lead market place 104 may also host web pages for the lead seller 102 to input information regarding what the lead seller 102 is selling, or for the lead buyer 103 to browse the information regarding the leads available for buying.

According to example embodiments, the lead seller 102 may be either a subject of the transaction lead or a third party providing information pertaining to a transaction lead. The information related to the on sale transaction lead inputted by the lead seller 102 may include selling preferences defined by the lead seller 102. The lead selling preferences may include a lead buyer score eligibility, a timeframe, an exclusive transaction lead minimum price, a non-exclusive transaction lead minimum price, and a seller black list containing a list of names of people the seller does not want to sell leads to them.

The information related to the demanded transaction lead may include buying preferences defined by the lead buyer 103. According to one example embodiment, facilitating a lead transaction by the lead market place 104 may include matching a demanded transaction lead and an on sale transaction lead in accordance with selling preferences defined by the lead seller 102 and the buying preferences specified by the lead buyer 103.

In an example embodiment, the third environment may include the lead market place 104, in which the lead buyer 103 may participate in a bidding process for the matched on sale transaction leads. According to an example embodiment, the lead market place 104 may include an online auction system. In the online auction system, the lead buyer 103 may have the option of authorizing the online auction system to, automatically; manage transaction lead purchasing processes, in accordance with predefined parameters. In an example embodiment, the predefined parameters may include a maximum bidding price, a zip code, a lead seller rating and a maximum amount that may be spent for leads in a specific period or maximum number of leads purchased in a specific period.

According to an example embodiment, the auction system may define the maximum number of successful lead buyers for any transaction lead. The auction system may also at the end of the auction period specified by the lead seller 102, determine a successful bidder.

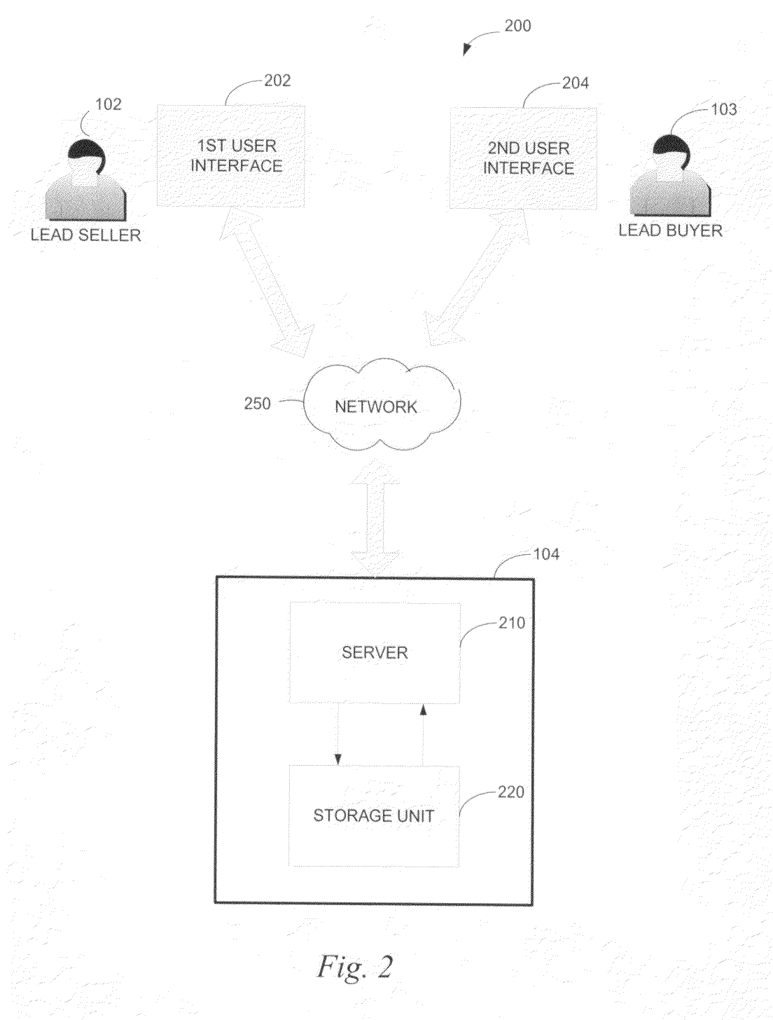

FIG. 2 is a high-level diagram depicting an example user-server system 200 within which an example lead transaction may take place. The example user-server 200 may include the lead seller 102, first user interface 202 (e.g., a Web page or a client application interface), the lead buyer 103, a second user interface 204 (e.g., a Web page or a client application interface) a network 250 (e.g., the Internet) and the lead market place 104.

The lead market place 104 may include a server 210 and storage unit 220. The lead buyer 102 and the lead seller 103 may use first user interface 202 and second user interface 204, respectively, to interact, via the network 250, with the lead market place 104.

The server 210 may use the network 250 to interact with the user interface 202 to get information from the selling party 102. According to one example embodiment, the information received by the server 210 from the lead seller 102 may also include preferences defined by the lead seller 102. The server 210, via the network 250, may also receive information through the user interface 204 from the lead buyer 103. The information received by the server 210 from the lead buyer 103 may include information regarding demanded leads by the lead buyer and the selling preferences defined by the lead buyer.

The server 210 may store the information received from the lead seller 102 and the lead buyer 103 in the storage unit 220. The server 210 may retrieve information received from the lead seller 102 and store it in the storage unit 220 to provide, via the network 250, to the lead buyer 103 through the second user interface 204. The server 210 may also retrieve information received from the lead buyer 103, via the network, and store the information in the storage unit 220 to present to the lead seller 102, via the user interface 202 and the network 250.

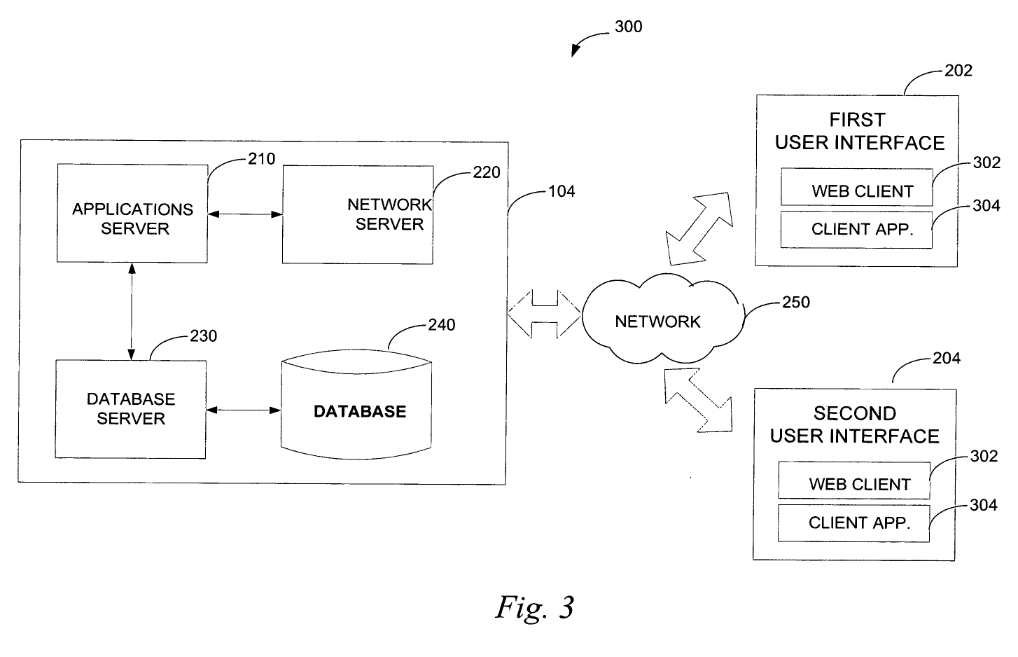

FIG. 3 is a block diagram illustrating an example embodiment of a system 300 including a lead market place in a network connection with users. System 300 may include the lead market place 104, the network 250, the first user interface 202 and the second user interface 204.

According to an example embodiment, the lead market place 104 may include an application server 210, a network server 220, a database server 230 and a database 240. In example embodiments, the first user interface 202 may include a Web client 302 or a client application 304. The second user interface 204 may include a Web client 302 or a client application 304.

In example embodiments, the first user interface 202 and the second user interface 204 may use the network 250 to interact with the lead market place 104. The application server 210 may host the lead market place applications 400, described in more detail, In example embodiments; the application server 210 may also provide access to the network 250, for the market place applications 400, via the network server 220. The application server may facilitate accessing to the database 240, via the database server 230, for the lead market place applications 400.

The database 240 may store the information received, via the network 250, from first user interface 202 and the second user interface 204. The database 240 may also store data provided by market place applications 400. The database server 230 may facilitate accessing to the network 250, for the application server 210.

### Lead Generation System Applications

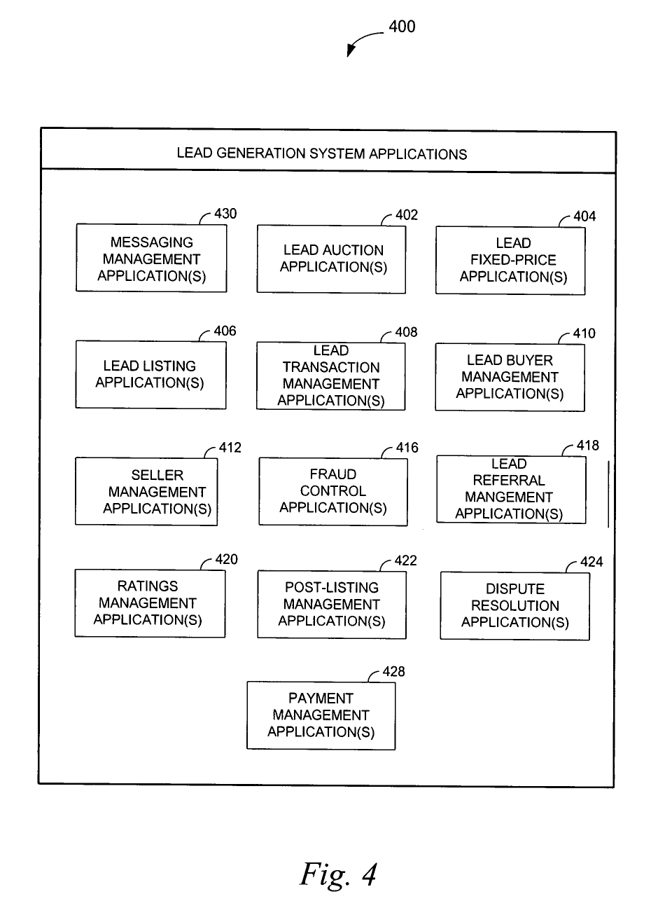

FIG. 4 is a diagram, illustrating lead generation system applications 400. The lead market place applications 400 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access network server 230, one or more database(s) 240 via the database server(s) 230.

The lead market place applications 400 may provide a number of publishing, listing and price-setting mechanisms whereby a lead seller may list (or publish information concerning) leads for sale, a lead buyer can express interest in or indicate a desire to purchase such leads, and a price can be set for a transaction pertaining to the leads. The lead market place applications 400 may include one or more lead listing application(s) 406 and one or more lead auction application(s) 402, which support auction-format listing and price setting mechanisms. The lead auction application(s) 402 may also provide a number of features in support of such auction-format listings, such as a reserve price feature whereby a lead seller may specify a reserve price in connection with a listing and a proxy-bidding feature whereby a bidder may invoke automated proxy bidding.

A number of lead fixed-price application(s) 404 may support fixed-price listing formats (e.g., the traditional classified advertisement-type listing or a catalogue listing) and buyout-type listings. Specifically, buyout-type listings may be offered in conjunction with auction-format listings, and allow a lead buyer to purchase leads, which are also being offered for sale via an auction, for a fixed-price that is typically higher than the starting price of the auction.

Rating management application(s) 420 may allow users that transact, utilizing the lead market place 104, to establish, build and maintain ratings, which may be made available and published to potential trading partners. Consider that where, for example, the lead market place 104 supports person-to-person trading, users may otherwise have no history or other reference information whereby the to assess the trustworthiness and credibility of potential trading partners. The Rating management application(s) 420 allow a user, for example through feedback provided by other transaction partners, to establish a standing within the lead market place 104 over time. Other potential trading partners may then reference such a standing for the purposes of assessing credibility and trustworthiness.

Lead listing application(s) 406 may allow lead sellers, conveniently, to author listings pertaining to leads that they wish to transact via the lead market place 104, and lead transaction management application(s) 408 may allow lead sellers to manage such listings. Specifically, where a particular lead seller has authored and/or published a large number of listings, the management of such listings may present a challenge. The lead transaction management application(s) 408 may provide a number of features (e.g., auto-relisting, inventory level monitors, etc.) to assist the lead seller in managing such listings.

One or more buyer management application(s) 410 may allow the lead market place 104 to maintain lists of all lead buyers 103, contact information related to lead buyers 103, leads associated with each lead buyer 103, all the information related to the leads transacted by the lead buyer 103, active lead lists associated with the lead buyers 103, watch list associated with the lead buyers 103, and the like.

One or more seller management application(s) 412 may allow the lead market place 104 to maintain lists of all lead sellers, lead sellers contact information, leads associated with each lead sellers, all the information related to the leads transacted by the lead sellers, lead sellers active lead lists, etc.

One or more payment management application(s) 428 may facilitate for the lead market place 104 to handle payments by the buyers, including managing lead buyers' accounts. The payment application (s) 428 may also manage lead seller's accounts, payment of lead transaction values to seller's accounts, and handling of commissions and service fees. The payment management application(s) 428 may also manage the payment of compensations to the lead referring parties reported by the referral management application(s) 418.

One or more lead referral management application(s) 418 may provide user interfaces to receive lead referrals from lead referring parties; verify the information related to the referred party; manage referral relationships between the lead referring party and the referred party (e.g. the level of direct indirections); reporting to the payment management application(s) 428, the due amounts to be paid to the lead referring parties as compensations, based on a percentage of the transaction values of a completed transactions as a result of the referrals.

One or more post-listing management application(s) 422 may also assist lead sellers with a number of activities that typically occur as post-listing. For example, upon completion of an auction facilitated by one or more lead auction application(s) 402, a lead seller may wish to leave feedback regarding a particular lead buyer. A post-listing management application(s) 422 may provide an interface to one or more ratings management application(s) 420, so as to allow the lead seller conveniently to provide feedback regarding multiple lead buyers to the ratings management application(s) 420.

Dispute resolution applications 424 may provide mechanisms whereby disputes arising between lead transacting parties may be resolved. For example, the dispute resolution applications 424 may provide guided procedures whereby the parties are guided through a number of steps in an attempt to settle a dispute. In the event that the dispute may not be settled via the guided procedures in a predetermined period (e.g., 7 days) the system may favor the lead buyer's case and refund the lead buyer (after subtracting service charges). In the event that there is no dispute claim after a certain period (e.g., 10 days) the transaction value (after subtracting service charges) may be transferred from the lead buyer to the lead seller.

One or more of fraud control application(s) 416 implement fraud detection and prevention mechanisms to reduce the occurrence of fraud within the lead market place 104.

Messaging management applications 430 may be responsible for the generation and delivery of messages to users of the lead market place 104, such messages, for example, advising users regarding the status of listings at the lead market place 104 (e.g., providing “outbid” notices to bidders during an auction process or to provide promotional and merchandising information to users). Respective Messaging management applications 430 may utilize any one of a number of message delivery networks and platforms to deliver messages to users. For example, Messaging management applications 430 may deliver electronic mail (e-mail), instant message (IM), Short Message Service (SMS), text, facsimile, or voice (e.g., Voice over IP (VoIP)) messages via the network (e.g., the Internet), Plain Old Telephone Service (POTS), or wireless (e.g., mobile, cellular, WiFi, WiMAX) networks.

### Data Structure

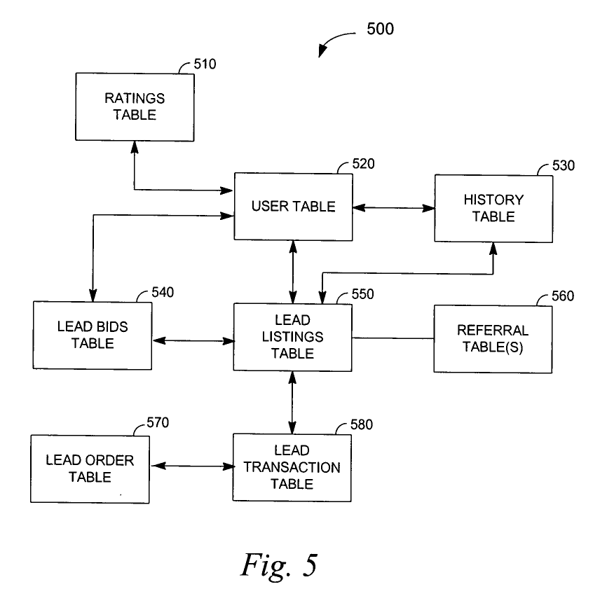

FIG. 5 is a high-level transaction lead generation entity-relationship tables 500 illustrating various tables that may be maintained within the databases; A user table 520 contains a record for each registered user of the lead market place 104, and may include identifier, address and financial instrument information pertaining to each such registered user. A user may operate as a lead seller, a lead buyer, or both, within the lead market place 104.

A lead transaction table 580 may contain a record for each lead transaction (e.g., a purchase transaction) pertaining to leads for which records exist within the leads listing table 550. A lead order table 570 may be populated with lead order records, each lead order record being associated with an lead order. Each lead order, in turn, may be with respect to one or more lead transactions for which records exist within the lead transactions table 580.

Lead bid records within a lead bids table 540 each may relate to a bid received at the lead market place 104 in connection with an auction-format listing supported by an lead auction application(s) 402. A ratings table 510 may be utilized by one or more ratings management application(s) 420, in one exemplary embodiment, to construct and maintain standing information concerning users.

A history table 530 may maintain a history of lead transactions to which a user has been a party. One or more referral tables 560 may record information pertaining to referrals on leads for which records may exist within the leads listing table 550.

### Flow Charts

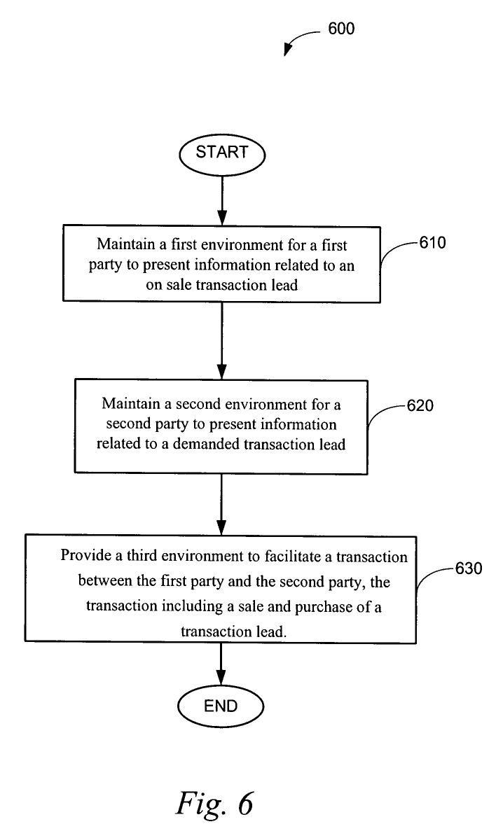

FIG. 6 is a high-level flow diagram, illustrating an example embodiment of a method 600 for a transaction lead generation. The method 600 starts at operation 610, where the lead market place 104 may maintain a Web page for the lead seller 102 to present information related to an on sale transaction lead. In one example embodiment, the Web page may include the first user interface 202.

At step 620, the lead market place 104 may maintain a web page for the lead buyer 103 to present information related to a demanded transaction lead. According to an example embodiment, the web page may include the user interface 204.

In the next step, at operation 630, the lead market place 104 may provide a Web page to facilitate a transaction between the lead seller 102 and the lead buyer 103. The transaction may include sale and purchase of a transaction lead.

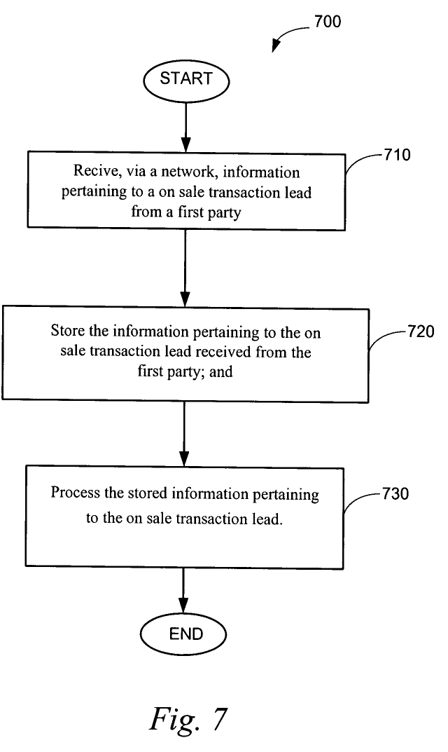

FIG. 7 is a high-level flow diagram, illustrating an example embodiment of a method 700 for registering transactions leads. The method starts at operation 710 where the lead market place 104 may receive, via network 250, information pertaining to an on sale transaction lead from a lead seller 102.

At operation 720, the lead listing application 406 of the lead market place applications 400 may use the application server 210 to store the information pertaining to the on sale transaction lead, received from the lead seller, via the network 250, on the database 240.

At step 730, the server 210, of the lead market place 104, may process the stored information pertaining to the on sale transaction lead. According to an example embodiment, processing the information related to the transaction lead may include matching the demanded transaction lead entered by a lead buyer 103 with on sale transaction leads offered by the lead seller 102, at the lead market place 104, in accordance with the selling preferences of the lead seller 102, and the buying preferences of the lead buyer 103.

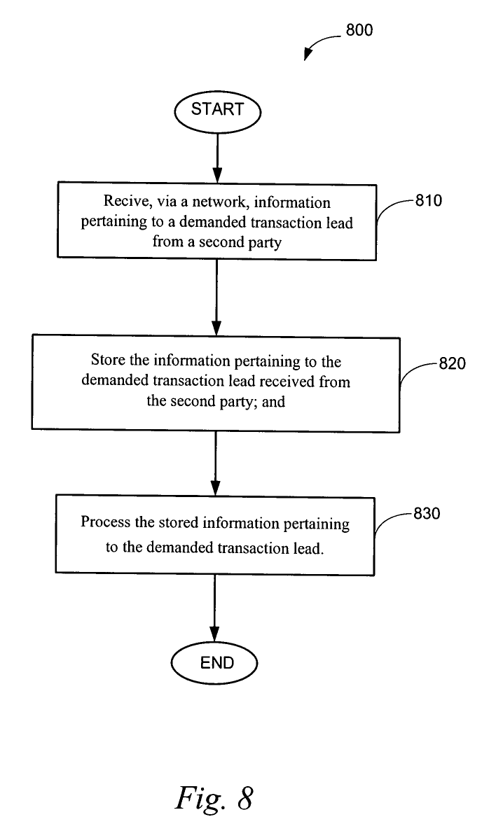

FIG. 8 is a flow diagram, illustrating an example embodiment of a method 800 for registering demands for transaction leads. The method 800 starts at operation 810, where the lead market place 104 may receive, via network 250, information pertaining to a demanded transaction lead, received from a lead buyer 103. According to an example embodiment, the information received from the lead buyer 103 may include the information related to one or more demanded transaction leads such as buying preferences defined by the lead buyer 103.

At operation 820, the lead listing application 406 may use the application server 210 to store the information pertaining to the demanded transaction lead received from the lead buyer 103 in the database 240.

At operation 830, the server 210 of the lead market place 104 may process the information pertaining to the demanded transaction lead received from the lead buyer 103. According to an example embodiment, the process may include matching the demanded transaction lead with an on sale transaction lead offered by the lead seller 102.

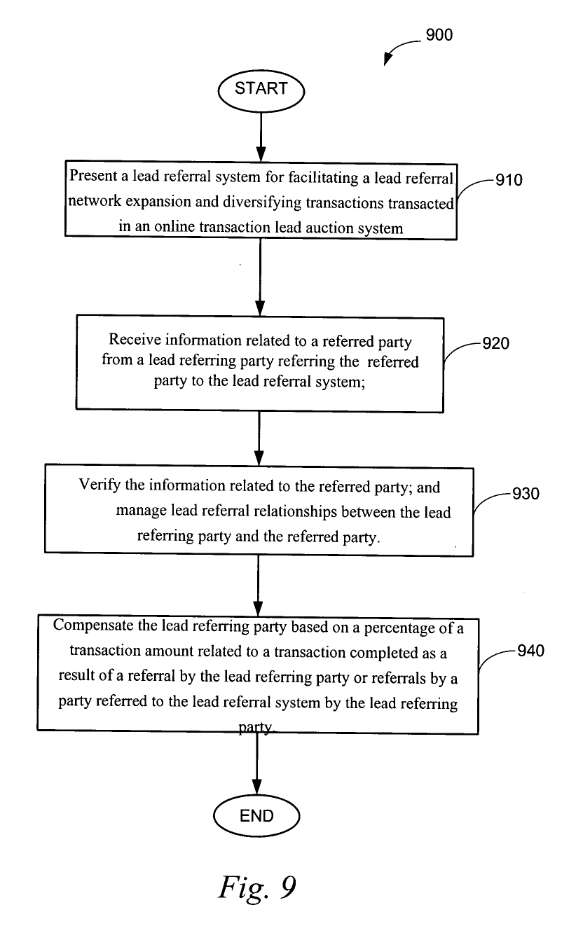

FIG. 9 is a flow diagram, illustrating an example embodiment of a method 900 for presenting a lead referral system for facilitating a lead referral network expansion and diversifying transactions transacted in an online transaction lead auction system. At operation 910, the lead market place 104 may present a lead referral system for facilitating a lead referral network expansion and diversifying transactions transacted in an online transaction lead auction system 104.

At operation 920, the lead referral management application 418 may receive information related to a referred party from a lead referring party referring the referred the party to the lead referral system.

At operation 930, the lead referral management application(s) 418 may verify the information related to the referred party and manage referral relationship between the referring party and the referred party.

At operation 940, the payment management application 428 may compensate the referring party based on a percentage of a transaction amount related to a transaction completed as a result of a referral by the referring party or referrals by a party referred to the referral system by the referring party. According to an example embodiment, the payment management application 428 may compensate the lead referring party by transferring to the lead referring party account, funds from an account holding commissions payable to the online auction system deducted from the transaction amount.

According to example embodiments, the lead referral system may be accessible to all users including one or more lead buyers and a lead seller associated with the transaction. The lead referral management application 418, in managing the lead referral relationship, may not limit the number of lead of referral relationships. The compensation of the lead referring party by the payment management application 428 may include a number indicating the maximum number of levels of direct interaction between lead referrals.

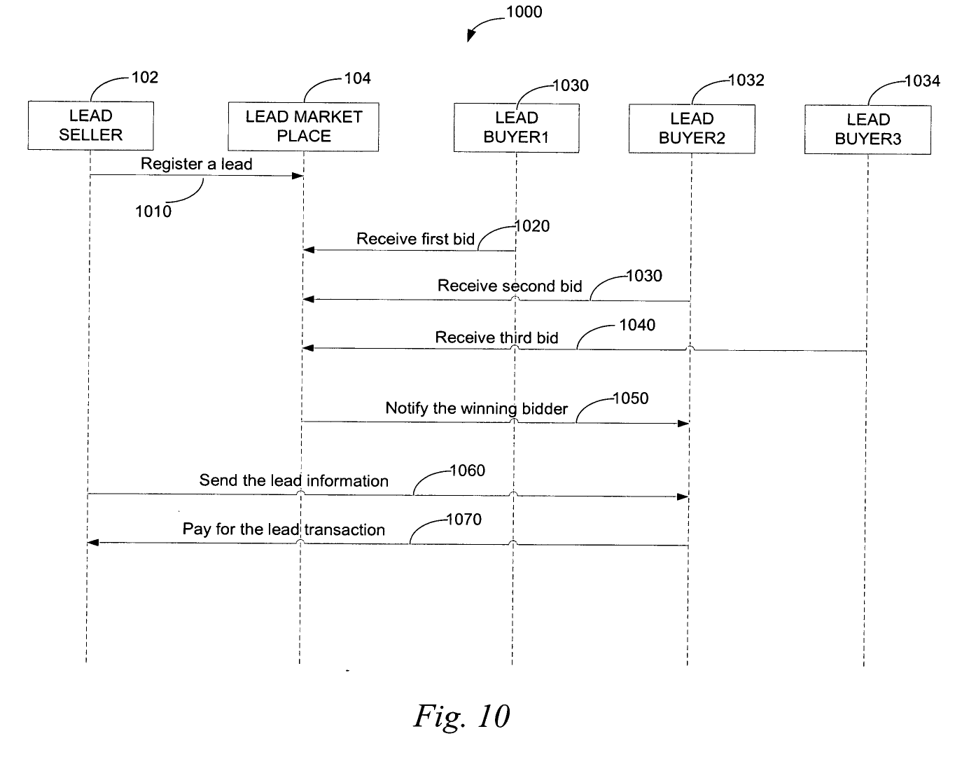

FIG. 10 is a sequential flow diagram, illustrating an example embodiment of an exclusive bidding process 1000 in the lead auction system. The exclusive bidding process 1000 starts with the lead seller 102 registering a lead, at operation 1010, with the lead auction system 104. Whilst the lead is registered at the lead auction system 104, the lead auction system 104, at operation 1020, may receive a first bid from a first buyer 1030.

In example embodiments, the lead market place 104 may also receive a second bid 1030 from a second lead buyer 1032 and a third bid 1040 received from third lead buyer 1034. After processing the received bids, the lead market place 104 may notify the winning bidder (e.g., the second lead buyer 1032) of the event. At this stage, the lead seller 102 may send the lead information, at operation 1060, to the winning bidder, second lead buyer 1032. In response, the second lead buyer 1032 may pay for the lead transaction, at operation 1070, to the lead seller 102.

### Screen Shots

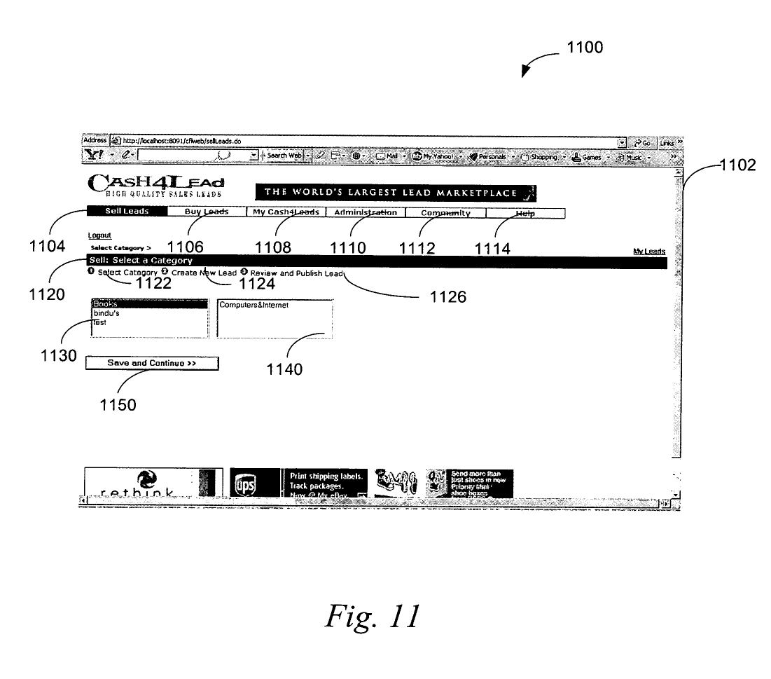

FIG. 11 is a screenshot 1100, illustrating an example embodiment of a user interface facilitating lead categories selection. In the user interface 1102, a plurality of menus are listed including sell leads 1104, buy leads 1106, my Cash4Leads 1108, administration 1110, community 1112, and help 1114. In the example embodiment shown in the interface 1102, the user has selected sell leads 1104 menu so the sell leads menu 1106 is active.

The user interface 1102 shows a “sell: select a category” section 1120 in which the user may select from select from among option of, select category 1122, create new lead 1124 or review and publish lead 1126. If the user wants to choose a category for the leads he is selling, he may click on select category 1122 in which the user may select from the categories shown in text box 1130. In the example shown, the books category is selected from text box 1130, and in box 1140, a sub category, namely, computers and internet is shown. After finishing with the user interface 1102, the user may want to save results and continue by pushing save and continue button 1150.

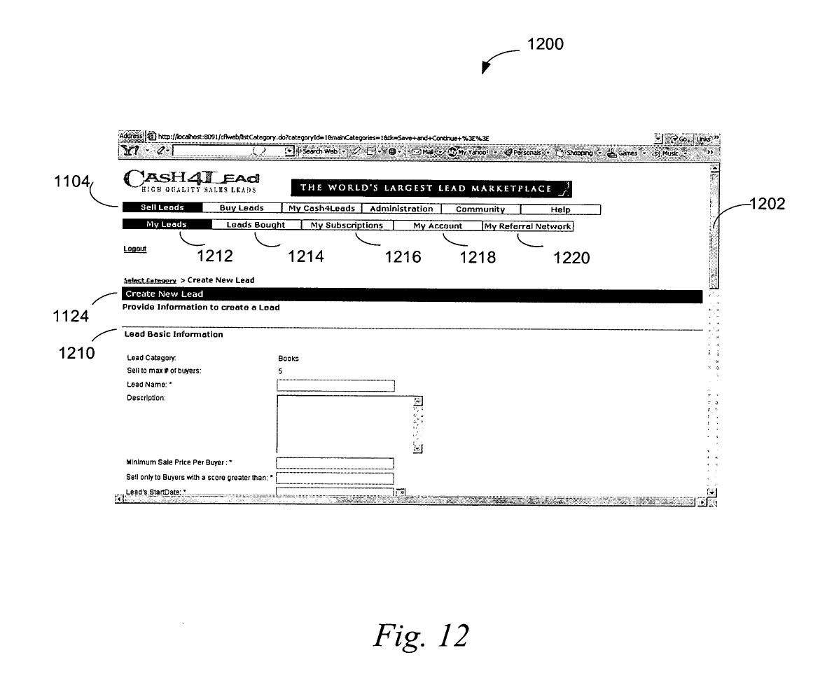

FIG. 12 is a screenshot 1200, depicting an example embodiment of a user interface 1202 for capturing lead basic information. After selecting a category, while the sell leads menu 1104 is still active, the user may be shown the interface 1202, in which a plurality of submenus including my leads 1212, leads bought 1214, my subscription 1216, my account 1218, and my referral networks 1220 are shown.

Also shown in the example 1202 interface is a create new lead section 1124 where the user may provide information to create a new lead. Under the section 1124, in a section 1210, entitled lead basic information, the user may provide lead seller preferences. The lead selling preferences may include a lead buyer score eligibility, a timeframe, an exclusive transaction lead minimum price, a non-exclusive transaction lead minimum price).

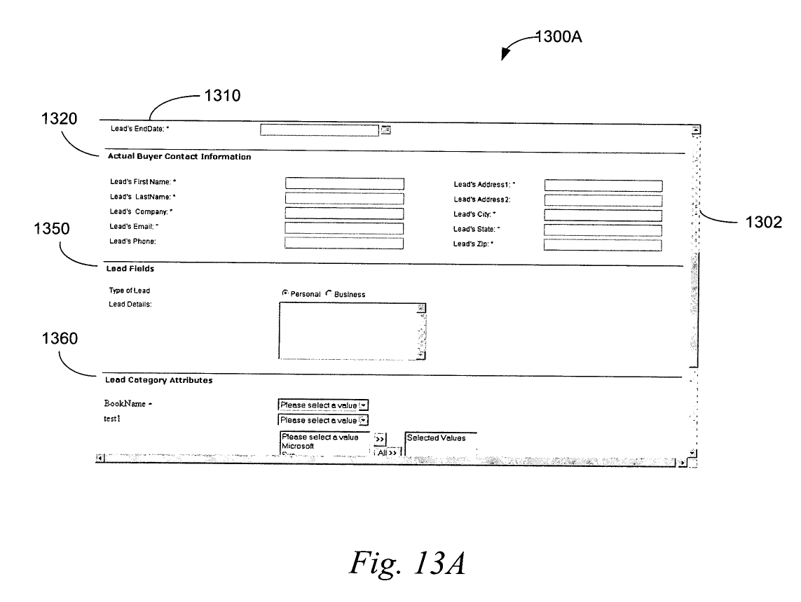

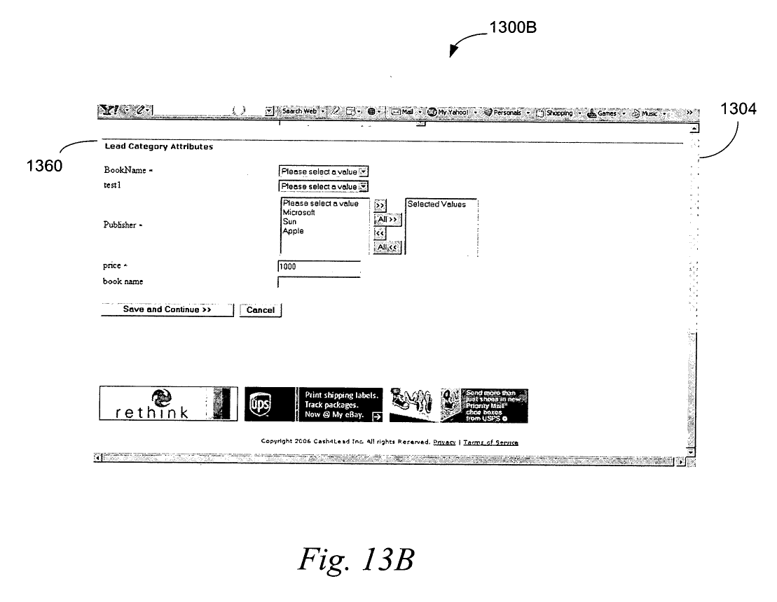

FIG. 13A is a screenshot 1300A, illustrating an example embodiment of a user interface for receiving information related to an actual buyer. The user interface 1302 is a continuation of the user interface 1202 where the user may specify the last item of the seller's preferences, namely leads end date 1310. In this example user interface, the user may also specify the actual buyer contact information. The actual buyer is the prospective buyer of an item or a service that lead buyer is interested in selling.

Under section entitled actual buyer contact information 1320, the user may specify the contact information related to the actual buyer including first name, last name, company name, email address, phone number, address one, address two, city name, state, zip code.

In the next section of the example interface entitled lead fields 1350, the user may specify the type of lead (e.g., personal or business) and the lead details. The last section 1360, in the example interface 1302, entitled lead category attribute. Since at interface 1102, the user has selected the books category, here the user may be given the option of selecting book category attributes.

FIG. 13B is a screenshot 1300B, illustrating an example embodiment of a user interface for receiving lead category attributes. Screenshot 1304 is a continuation of the screenshot 1302, where the lead category attribute section 1360 is shown. The example interface indicates that the book name is selected under the category for which the attributes are to be specified. However, the user is given a choice to select another category, if desired. Among the lead category (e.g., Book Name) attributes including test 1 {INVENTOR, WHAT IS THIS?}, publisher name, price, and book name are listed. After specifying the attributes or selecting related items from the selection boxes, the user may save the information and continue or cancel.

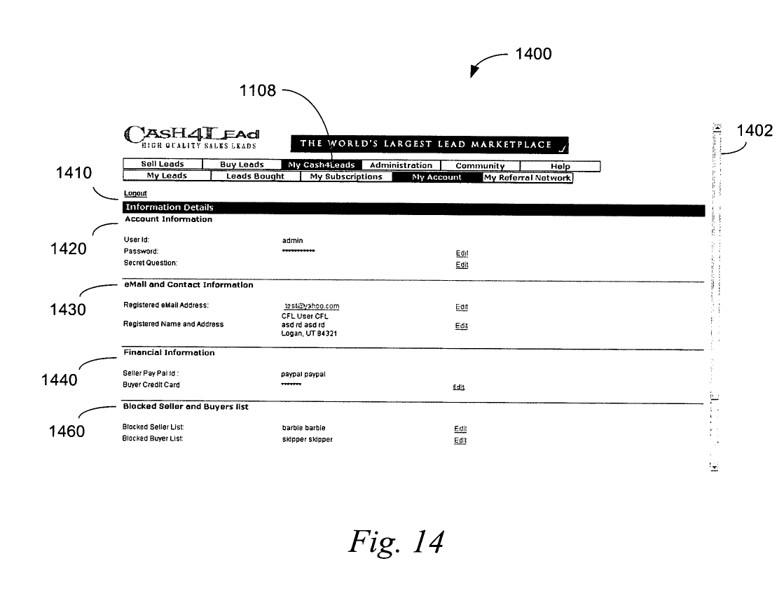

FIG. 14 is a screenshot 1400, depicting an example embodiment of a user interface for capturing detailed lead buyer/seller account information. In the example user interface 1402 shown in the figure, the menu my Cash4Leads 1148 and the submenu my account 1218 are active.

In the example interface 1402, under section 1410 titled information details, the user may find subtitles including account information 1420, email and contact information 1430, financial information 1440, block seller and buyer list 1460.

Under the account information 1420, the user may enter a user ID, a password and a secret question.

Under email and contact information 1430, the user may enter a registered email address (e.g. test@yahoo.com); a registered name and address (e.g. cash for lead user CFL, ASO, Logan, Utah 84321).

Under financial information 1440, user may be able to enter a seller PayPal ID (e.g. PayPal) and a buyer credit card number.

Under block seller and buyer list 1460, the user may be able to block any seller or any buyer by specifying their name in the block seller list or block buyer list.

In front of all of the information entered under information detail 1410, there is an edit button where the user may edit all the information entered previously.

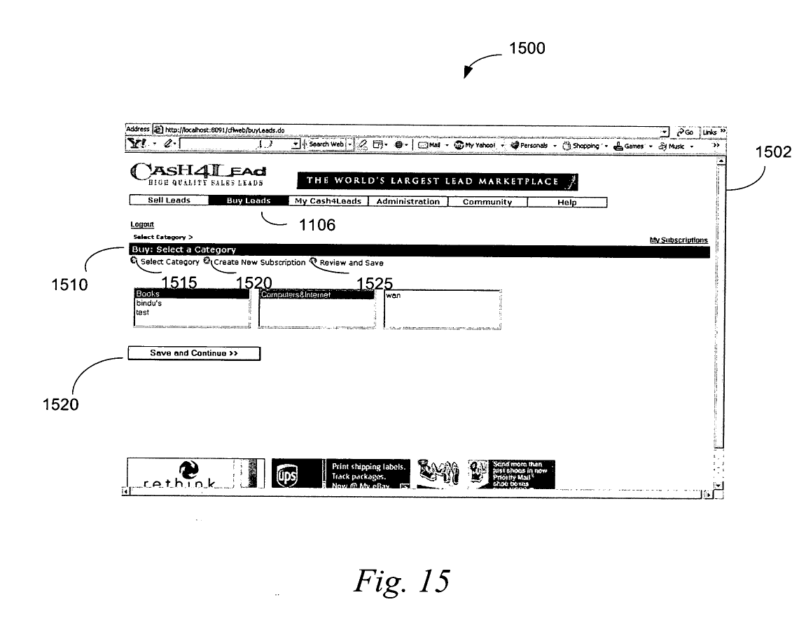

FIG. 15 is a screenshot 1500, illustrating an example embodiment of a user interface for capturing demanded lead information from a lead buyer. In the example user interface 1502, the menu item buy leads 1160 is active. In t user interface 1502, the lead buyer 103 may start to specify the demanded leads that the lead buyer is interested in buying.

In the user interface 1502, under section entitled “buy: select a category” 1510, there are three options that may select from. The options may include select category 1515, create new subscription 1520 and review and save 1525. In the interface 1502, the select category 1515 is active, where the user may select a category (e.g. books) or a subcategory (e.g. computers and internet) and may be another subcategory (e.g. WAN). The user may then save the entered information, continue by pushing the save, and continue button 1520.

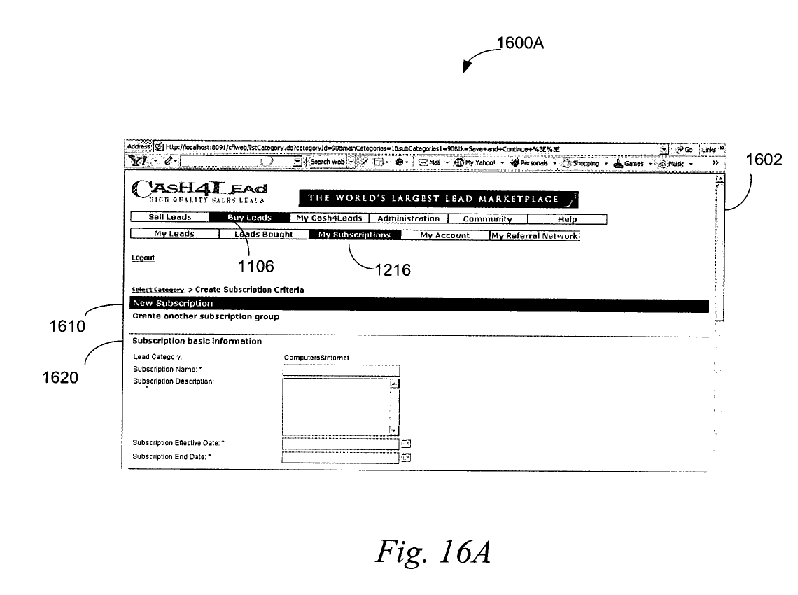

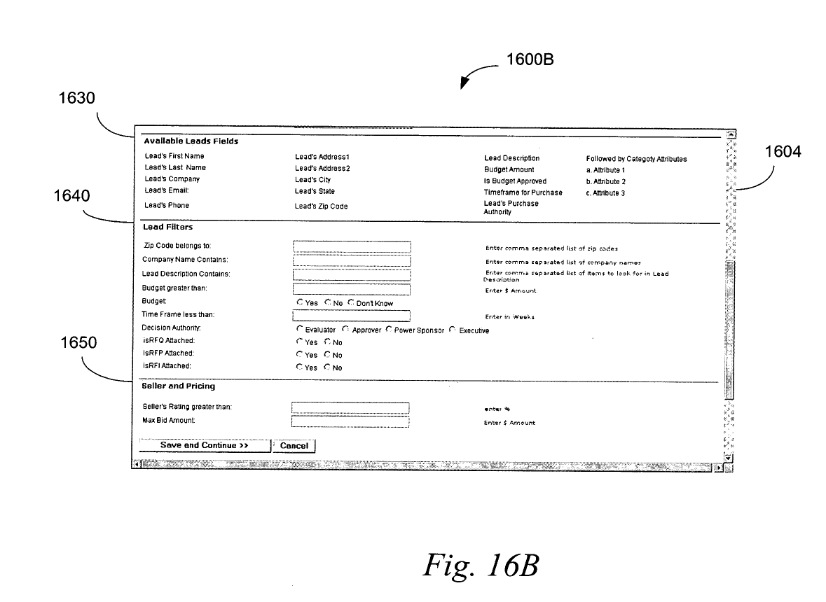

FIG. 16A is a screenshot 1600A, illustrating an example embodiment of a user interface for creating subscription criteria. In the example user interface 1602 designated in the figure, the buy leads 1106 menu and the my subscription 1216 submenu are active.

In the example interface shown under section new subscription 1610, the user may create a new subscription by entering information in section 1620, where the user may provide basic information including lead category, subscription name, subscription description, subscription effective date and subscription end date.

FIG. 16B is a screenshot 1600B, illustrating an example embodiment of a user interface for receiving lead filter information from a lead buyer. The example user interface 1604 shown in the figure may include sections entitled available lead fields 1630, lead filters 1640, seller and pricing 1650, which are in fact subsections of the section 1610 entitled new subscription shown in FIG. 16A.

Under subsection available lead fields 1630, the user may provide information related to the lead including first name, last name, company name, email address, phone number, address 1, address 2, city, state, zip code, lead description, budget amount, is budget approved, timeframe for purchase, purchase authority, followed by category attributes, attribute 1, attribute 2 and attribute 3.

Under subsection lead filters 1650, fields are provided for a lead buyer 103 to specify the limitations on the lead he is interested in buying. The limitations may include a zip code that the lead may belong to, a keyword contained in the company name, a keyword contained in lead description, a minimum budget, whether budget with options is acceptable (answers include yes, no, don't know), higher limit on time frame, decision authority (with options including evaluator, approver, power sponsor, and executive); is RFQ attached (answer may include yes, no); is RFP attached (answer may include yes, no); is RFI attached (answer may include yes, no).

On the seller and pricing subsection 1650 fields are provided for the user to enter seller's rating greater than max bid amount, after that the user may save and continue or cancel.

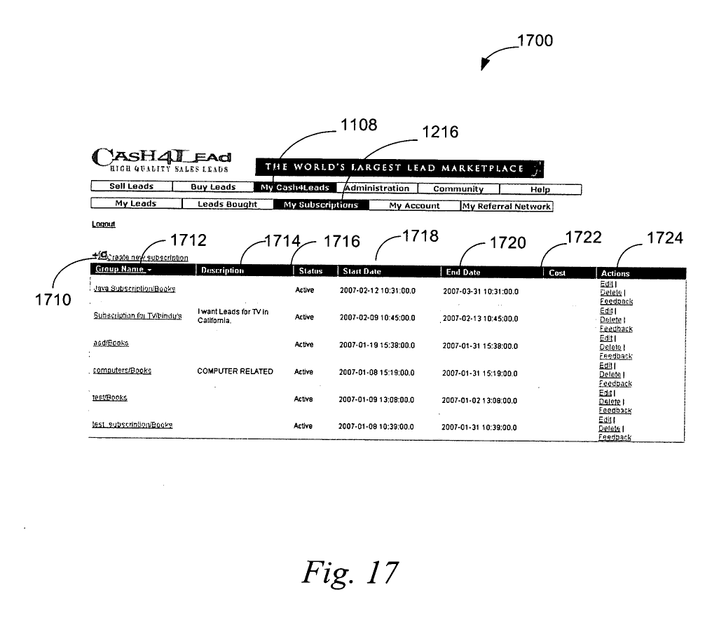

FIG. 17 is a screenshot 1700, depicting an example embodiment of a user interface for creating a new subscription. In the shown example user interface 1702, menu option, my Cash4Leads 1108, and the submenu, my subscriptions 1216 are active.

The example user interface 1702 may provide a section 1710, titled create new subscription, under which the user may include the information including group name 1712, description 1714, starters 1716, start date 1718, end date 1720, cost 1720 and actions 1724.

Under group name 1712, the user may specify a name for a subscription group e.g. Java subscriptions/books, ASD/books, test/books and the like. Under description column 174, the user may specify the description of each of the group name. For example, for subscription for television (TV) the user may specify a description, such as “I want leads for TV in California”. Under status column 1716 the user may specify the status of the subscription (e.g., active). Under a start date column 1716, the user may specify the start date and time for the new subscription (e.g., Feb. 12, 2007 at 10:30 am).

Under end date column 1720, the user may specify the ending date for the new subscription. For example, Mar. 31, 2007 at 10:30 pm. Under cost column 1722, the user may specify the total cost he is ready to accept for the new subscription. Under actions column 1724 the user may be provided with options of editing, deleting or going to the feedback for each of the subscription in the list.

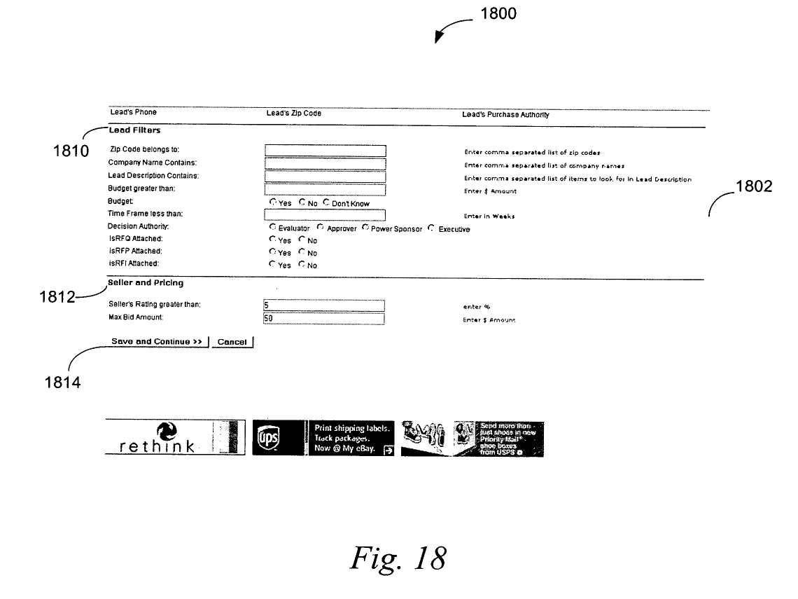

FIG. 18 is a screenshot 1800, illustrating an example embodiment of a user interface for receiving feedback from lead buyers 103 and lead sellers 102. In the example user interface 1802 shown in the figure, the menu, community 1112, is active. The user interface 1802 as shown in the Figure may include a section feedback from 1810 and subsection lead feedback 1812 and a reminder section 1814.

Under lead feedback subsection 1812, the user may enter a user ID or item number or may be able to search for the user name and ID number if a lead the user is interested in leaving feedback for.

Under reminder section 1814, the user is reminded of a transaction for which the user may leave feedback. In this section, a seller name and a lead name may be specified. The user may be given the option of selecting the lead disposition. The options may include quick lead, back lead, duplicate, and I will leave feedback later. The user may also enter up to 80 characters of comments in this specified field.

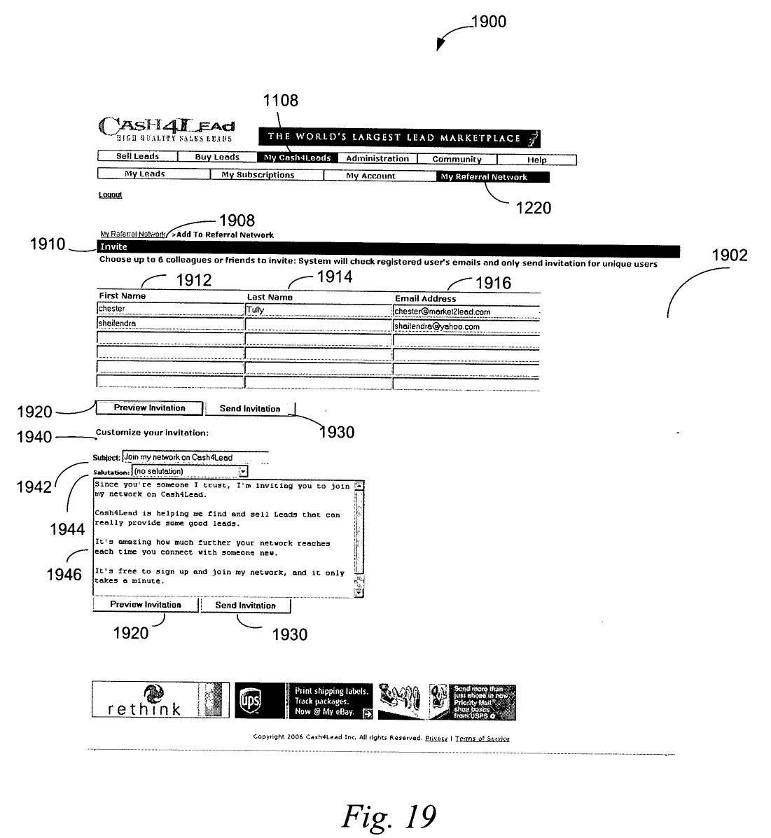

FIG. 19 is a screenshot 1900, illustrating an example embodiment of a user interface for inviting others to join the lead referral system. In the example user interface 1902 shown in the figure, the menu, my Cash4Leads 1108 and the submenu, my referral network 1220, are active.

In the example interface shown under actual referral network 1908, the user may go to the invite section 1910 and choose up to six colleagues or friends to invite them to the system. The system may check registered users' emails and only send invitations for unique users. The invite section 1910 may provide three columns including columns entitled first name 1912, last name 1914, email address 1916, in which the user may enter information related to six colleagues or friends.

After entering the information, the user may want to preview the sent invitation by pressing the preview invitation button 1920 or sending the invitation to the invitee by pressing send invitation button 1930.

The user interface 1902 at section 1940 provides for the user to customize the invitation. In customize your invitation section 1940; the user may enter the subject 1942, salutation 1944 and an invitation message 1946.

Again, finishing with the user interface, the user may select to preview the invitation by pressing preview invitation button 1920 or send the invitation by pressing the send invitation button 1930.

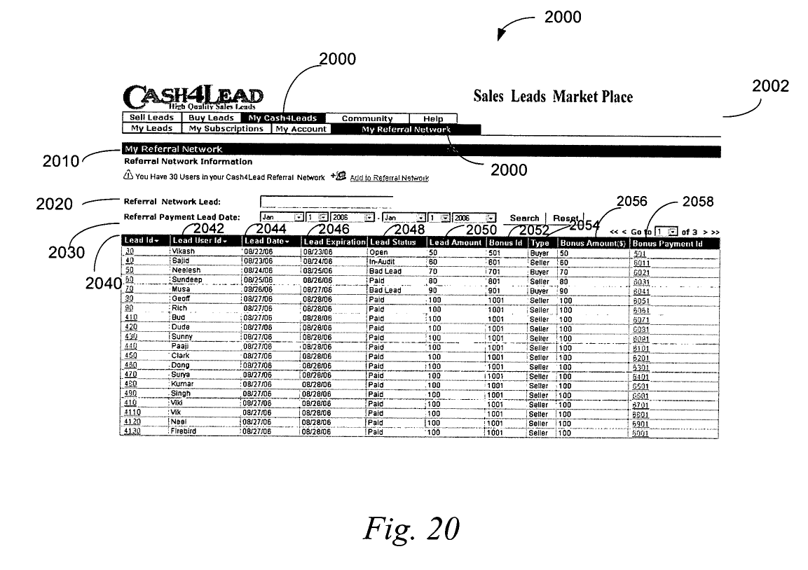

FIG. 20 is a screenshot 2000, illustrating an example embodiment of a user interface for showing the lead referral network of an account. In the example user interface 2002 shown in the figure, the menu option, my Cash4Leads 1108 and the submenu, my referral network 1220, are active.

The user interface 2002, under section 2010 entitled my referral network, the user may enter the referral network lead name 2020 or a range of dates for the referral payment lead date 2030, to find the information related to those leads. The information related to the desired referral network lead may be described in a table including lead ID 2040, lead user ID 2042, lead date 2044, lead expiration 2046, lead status 2048, lead amount 2050, bonus ID 2052, type 2054, bonus amount 2056, bonus payment ID 2058.

In the lead market place 104, the leads are not specified by their actual name; instead, they are specified by a lead ID number and a lead user ID, as shown in columns 2040 and 2042. The lead date 2044 designates a date that the lead actually entered the system. Lead expiration 2046 represents the expiration date for each offered lead. Lead status 2048 indicates the status of the lead (e.g. open, in audit, bad lead, paid et cetera). Under lead amount column 2050, columns, lead amount 2050 and lead bonus amount 2056, may indicate the dollar amount for each lead specified in the table. Bonus ID column 2052 and bonus payment ID 2058 are bonus identification and bonus payment identification for the lead ID and associated by lead amounts payable for that lead.

### Machine Architecture

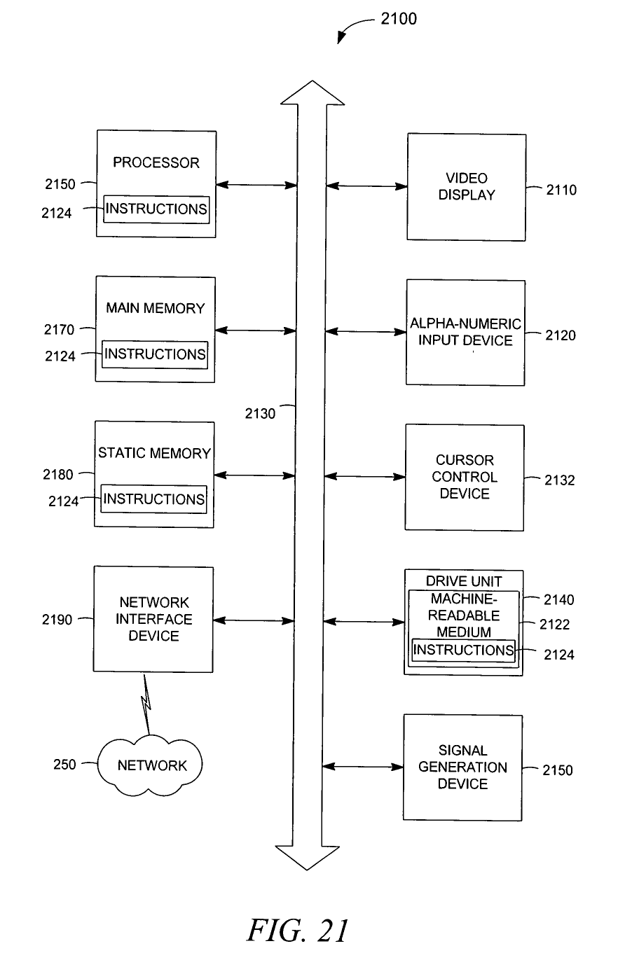

FIG. 21 is a block diagram, illustrating a diagrammatic representation of machine 2100, in the example form of a computer system within which a set of instructions, for causing the machine to perform any one or more of the methodologies discussed herein, may be executed. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2100 may include a processor 2160 (e.g., a central processing unit (CPU) a graphics processing unit (GPU) or both), a main memory 2170 and a static memory 2180, which communicate with each other via a bus 2130. The computer system 2100 may further include a video display unit 2110 (e.g., liquid crystal displays (LCD) or cathode ray tube (CRT)). The computer system 2100 also may include an alphanumeric input device 2120 (e.g., a keyboard), a cursor control device 2132 (e.g., a mouse), a disk drive unit 2140, a signal generation device 2150 (e.g., a speaker) and a network interface device 2190.

The disk drive unit 2140 may include a machine-readable medium 2122 on which is stored one or more sets of instructions (e.g., software 2124) embodying any one or more of the methodologies or functions described herein. The software 2124 may also reside, completely or at least partially, within the main memory 2170 and/or within the processor 2160 during execution thereof by the computer system 2100, the main memory 2170 and the processor 2160 also constituting machine-readable media.

The software 2124 may further be transmitted or received over a network 426 via the network interface device 2190.

While the machine-readable medium 2122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

Thus, a method and a system of lead generation and lead demand fulfillment are provided. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for lead generation comprising:
maintaining a first environment for a first party to present information related to at least one on sale transaction lead, the on sale transaction lead being a transaction lead the first party is interested in selling;
maintaining a second environment for a second party to present information related to at least one demanded transaction lead, the demanded transaction lead being a transaction lead the second party is interested in buying; and
providing a third environment to facilitate a transaction between the first party and the second party, the transaction including a sale and purchase of a transaction lead.

2. The method of claim 1, further comprising subscribing by the second party to a transaction lead category provided by the second environment.

3. The method of claim 1, further comprising specifying by the first party at least one transaction lead category for the on sale transaction.

4. The method of claim 1, further comprising identifying the first environment and the second environment as web pages hosted by a server facilitating a user to perform one or more actions selected from a group of actions consisting of browsing information and inputting data.

5. The method of claim 1, further comprising identifying the first party either as being the subject of the transaction lead or as being a third party providing information pertaining to a transaction lead.

6. The method of claim 1, further comprising recognizing that the information related to the at least one on sale transaction lead as including selling preferences defined by the first party.

7. The method of claim 6, further comprising recognizing the selling preferences as including a lead buyer score eligibility, a timeframe, an exclusive transaction lead minimum price, a non-exclusive transaction lead minimum price, and a seller black list.

8. The method of claim 6, further comprising recognizing the information related to the at least one demanded transaction lead as including buying preferences defined by the second party, the buying preferences including a transaction lead category, a transaction lead description, a time frame, a lead seller zip code, a budget, an amount willing to pay for an exclusive transaction lead, an amount willing to pay for a non-exclusive transaction lead, and a buyer black list.

9. The method of claim 8, wherein the facilitating a transaction includes matching a demanded transaction lead with an on sale transaction lead, at least in accordance with the selling preferences and the buying preferences.

10. The method of claim 9, further including notifying the first and the second party of a matching transaction lead.

11. The method of claim 1, further comprising recognizing the third environment as a market place environment for the second party to participate in a bidding process for the matched on sale transaction lead.

12. The method of claim 11, wherein the market place is identified as an online auction system.

13. The method of claim 12, wherein the second party has the option of authorizing the online auction system to automatically manage transaction lead purchasing processes in accordance with predefined parameters, the predefined parameters including a maximum bidding price, a zip code, a lead seller rating, and at least one of a maximum amount spent for leads in a period, or a maximum number of leads purchased in a period.

14. The method of claim 12, further comprising identifying, by the auction system, a maximum number of successful lead buyers for a transaction lead, of the at least one on sale transaction lead.

15. The method of claim 14, further comprising specifying by the first party an auction period and upon ending of the auction period, the auction system automatically identifying at least one successful bidder.

16. The method of claim 15, further comprising receiving, by the first party, ratings form the at least one successful bidder and receiving, by the at least one successful bidder, a rating from the first party.

17. The method of claim 16, wherein the ratings comprises one of good lead, bad lead, or duplicate lead.

18. The method of claim 14, further comprising the first party having identification attributes, wherein the identification attributes are prevented from being disclosed to the second.

19. The method of claim 1, wherein the maintaining of the second environment facilitates transaction lead buying campaigns including presenting the second party with all subscription options.

20. The method of claim 19, wherein the presenting the second party with all subscription options includes presenting the second party with options to define a maximum bid price for a subscription selection, a maximum number of transaction lead to be purchased during a predefined timeframe, and a maximum amount to be spent in the predefined timeframe.

21. The method of claim 15, further comprising notifying the at least one successful bidder via email messages that the at least one successful bidder has purchased the transaction lead, automatically transferring the purchase amount, and deducting the commission.

22. The method of claim 1, further comprising providing a public community forum for public discussions on lead transactions, wherein aliases are used to protect identity of participating parties.

23. A method comprising:
receiving, via a network, information pertaining to an on sale transaction lead from a first party, the on sale transaction lead being a transaction lead the first party is interested in selling;
storing the information pertaining to the on sale transaction lead received from the first party; and
processing the stored information pertaining to the on sale transaction lead.

24. The method of claim 23, further comprising identifying the first party either as the subject of the on sale transaction lead or as a third party providing information pertaining to a transaction lead.

25. The method of claim 23, further comprising recognizing that the information related to the on sale transaction lead as including selling preferences defined by the first party.

26. The method of claim 25, further comprising recognizing the selling preferences as including a lead buyer score eligibility, a timeframe, an exclusive transaction lead minimum price, a non- exclusive transaction lead minimum price, a seller black list.

27. The method of claim 25, wherein the processing the stored information includes presenting the on sale transaction lead to be sold in an auction system based on the selling preferences.

28. A method comprising:
receiving, via a network, information pertaining to a demanded transaction lead from a second party, the demanded transaction lead being a transaction lead the second party is interested in buying;
storing the information pertaining to the demanded transaction lead received from the second party; and
processing the stored information pertaining to the demanded transaction lead.

29. The method of claim 28, further comprising recognizing the information related to the at least one demanded transaction lead as including buying preferences defined by the second party.

30. The method of claim 28, wherein the processing the stored information includes matching a demanded transaction lead with an on sale transaction lead, at least in accordance with selling preferences defined by a selling party and buying preferences defined by the second party.

31. The method of claim 28, further comprising recognizing the second party subscribing to at least one transaction lead category.

32. The method of claim 29, further comprising recognizing the buying preferences as including a transaction lead category, a transaction lead description, a time frame, a lead seller zip code, a budget, an amount willing to pay for an exclusive transaction lead, an amount willing to pay for a non-exclusive transaction lead, and a buyer black list.

33. A method comprising:
presenting a lead referral system for facilitating a lead referral network expansion and diversifying transactions transacted in an online transaction lead auction system;
receiving information related to at least one referred party from a lead referring party referring the at least one referred party to the lead referral system;
verifying the information related to the at least one referred party; and
managing lead referral relationships between the lead referring party and the at least one referred party.
compensating the lead referring party based on a percentage of a transaction amount related to a transaction completed as a result of a lead referral by the lead referring party or lead referrals by at least one party referred to the lead referral system by the lead referring party.

34. The method of claim 33, wherein compensating the lead referring party is by transferring to a lead referring party account funds from an account holding commissions, payable to the online auction system, deducted from the transaction amount.

35. The method of claim 33, wherein the lead referral system is accessible to all users including one or more lead buyers and a lead seller associated with a transaction.

36. The method of claim 33, wherein managing a lead referral relationship does not limit a number of lead referral relationships.

37. The method of claim 36, wherein the compensating of the lead referring party includes a number, indicating a maximum number of levels of direct indirection between lead referrals.

38. A system comprising:
a first user interface to receive, via a network, from a first party, information related to at least one on sale transaction lead, the on sale transaction lead being a transaction lead the first party is interested in selling;
a second user interface to receive, via a network, from a second party, information related to at least one demanded transaction lead, the demanded transaction lead being a transaction lead the second party is interested in buying; and
a server to process the information related to the demanded transaction leads and the on sale transaction leads.

39. The system of claim 38, wherein the first user interface is to provide the first party with options to input selling preferences including a lead buyer score eligibility, a timeframe, an exclusive transaction lead minimum price, a non-exclusive transaction lead minimum price, and a seller black list.

40. The system of claim 39, further comprising the second user interface to present the second party with two or more items of the information related to each of the at least one on sale transaction lead.

41. The system of claim 40, wherein the second user interface is to provide the second user with options to input buying preferences including a transaction lead category, a transaction lead description, a time frame, a lead seller zip code, a budget, an amount willing to pay for an exclusive transaction lead, an amount willing to pay for a non-exclusive transaction lead, and a buyer black list.

42. The system of claim 41, wherein the sever is to, at least match the demanded transaction lead with an on sale transaction lead, at least in accordance with the selling preferences and the buying preferences.

43. A system comprising:
a user interface to receive, from a first party, information related to at least one on sale transaction lead, the on sale transaction lead being a transaction lead the first party is interested in selling;
a storage unit to store the information pertaining to the on sale transaction lead received from the first party; and
a server to process the stored information pertaining to the on sale transaction lead.

44. The system of claim 43, wherein the first user interface is to provide the first party with options to input selling preferences including a buyer score eligibility, a timeframe, an exclusive transaction lead minimum price, a non- exclusive transaction lead minimum price, and a seller black list.

45. The system of claim 43, wherein the sever is to present the transaction lead to be sold in an auction system based on the selling preferences.

46. A system comprising:
a user interface to receive, from a second party, information related to at least one demanded transaction lead, the demanded transaction lead being a transaction lead the second party is interested in buying;
a storage unit to store the information pertaining to the demanded transaction lead received from the second party; and
a server to process the stored information pertaining to the demanded transaction lead.

47. The system of claim 46, wherein the user interface is to provide the second user with options to input buying preferences including a transaction lead category, a transaction lead description, a time frame, a lead seller zip code, a budget, an amount the second party is willing to pay for an exclusive transaction lead, an amount the second party is willing to pay for a non-exclusive transaction lead, and a buyer black list.

48. The system of claim 46, wherein a server is to at least, match the demanded transaction lead with an on sale transaction lead.

49. A machine-readable medium embodying instructions, the instructions, when executed by a machine, causing the machine to:
maintain a first environment for a first party to present information related to at least one on sale transaction lead, the on sale transaction lead being a transaction lead the first party is interested in selling;
maintain a second environment for a second party to present information related to at least one demanded transaction lead, the demanded transaction lead being a transaction lead the second party is interested in buying;
store the information related to the on sale transaction leads and the demanded transaction leads; and
processes the information related to the on sale transaction leads and the demanded transaction leads.

50. A machine-readable medium embodying instructions, the instructions, when executed by a machine, causing the machine to:
identify a lead referral system for facilitating a lead referral network expansion and diversifying transactions transacted in an online transaction lead auction;
receive information related to at least one referred party from a lead referring party referring the at least one referred party to the lead referral system;
verify the information related to the at least one referred party;
manage lead referral relationships between the lead referring party and the at least one referred party; and
compensate the lead referring party based on a percentage of a transaction amount related to transaction completed as a result of a lead referral by the lead referring party or lead referrals by at least one party referred to the lead referral system by the lead referring party.

51. The method of claim 1, further comprising:
facilitating dispute resolution between the first party and the second party in a lead transaction, by:
maintaining a communication channel, accessible only by the first party and the second party;
detecting whether a dispute between the first party and the second party is not settled within a period;
responsive to the detection, refunding the second party.
